(19) United States
(12) Patent Application Publication
(10) Pub. No.: US 2022/0044269 A1
(43) Pub. Date: Feb. 10, 2022

(54) SYSTEM AND METHOD FOR CONTACTLESS SALES USING LOCATION-BASED SERVICES

(71) Applicant: Bandits Roost LLC, New York, NY (US)

(72) Inventors: Cori Silberman-Sais, New York, NY (US); Michael Sais, New York, NY (US)

(21) Appl. No.: 17/394,503

(22) Filed: Aug. 5, 2021

Related U.S. Application Data
(60) Provisional application No. 63/061,323, filed on Aug. 5, 2020.

(51) Int. Cl. G06Q 30/02; G06Q 20/04; G06F 16/2457

(52) U.S. Cl. CPC G06Q 30/0207; G06Q 30/0261; G06F 16/24575; G06Q 30/0267; G06Q 20/0457; G06Q 30/0252

(57) ABSTRACT

A system for facilitating transactions at a venue, the system comprising a processor and a memory having executable instructions stored thereon that when executed by the processor cause the processor to determine a location of a client device based on location sensor data received from the client device, select an offer based on the location of the client device and an event at a venue a user of the client device is attending, and generate a message to the client device based on the offer.

### CROSS REFERENCE TO RELATED APPLICATION

This application claims the priority of U.S. Provisional Application No. 63/061,323, entitled “SYSTEM AND METHOD FOR CONTACTLESS SALES USING LOCATION-BASED SERVICES,” filed on Aug. 5, 2020, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to a mobile retail application and platform, and in particular, a contactless system that uses location-based services to connect businesses with consumers at event venues.

### Description of the Related Art

Currently, no solution exists that allows for event producers or venues to interact with their consumer to sell and upsell concessions and merchandise, with direct messaging prompts for items, delivery to seat/space or home location, and provide geo-located recommendations and suggestions for items or other events.

There are several barriers to entry regarding engagement and sales particularly with ticketing, concessions and merchandize around a live theatrical event. Even prior to COVID-19, the physical acquisition of tickets, concessions and merchandise was a daunting process. Between long ticket queues, TKTS booths, patrons arriving to the theater late, limited time during intermission, long restroom lines, patrons wrangling children, patrons needing to rush home after the show, and the additional swipe of the credit card, and quickly leaving the theater after a performance, the very nature of ticketing, concessions and merchandise in theater was essentially one large barrier to entry for consumers.

Now, in the COVID-19 world, that barrier is that much more impenetrable as acquiring tickets, concessions and merchandise will all be viewed as just another point of contact that patrons should avoid at all costs, while remaining essential revenue streams that production companies, producers and theaters need to preserve at significant cost. Additionally, with all the time, money and energy dedicated to engage a patron during the show, there is almost no mechanism in place to facilitate a long-term relationship with patrons after they leave. This forces production companies, producers and theaters into a no-win scenario where if they fail to make both concession and merchandise sales in at best, a 10-minute window, the sale is lost forever.

There is thus a need to solve the problems of contactless concessions and merchandise.

### SUMMARY OF THE INVENTION

The present invention provides systems and methods for facilitating transactions at a venue. According to one embodiment, the system comprises a processor and a memory having executable instructions stored thereon that when executed by the processor cause the processor to determine a location of a client device based on location sensor data received from the client device, select an offer based on the location of the client device and an event at a venue a user of the client device is attending, and generate a message to the client device based on the offer.

The processor may be further configured to add entries to a location-based offering database including offers based on geographic locations, determine that the client device entered or is proximate to a given one of the geographic locations, and generate an offer corresponding to the given one of the geographic locations. The message may include at least one of a name and address of a merchant, conditions of the offer, and a time limit of the offer. The processor may be configured to receive a query from the client device for information about offers that have associated geographic locations that are proximate to the location of the client device. The processor may be configured to receive a query from the client device for information about offers that have associated geographic locations that are proximate to a future location intended. The processor may also be configured to interact with a customer relations server to conduct transactions with advertiser and merchant devices or a venue server. The transactions may include purchasing of tickets, merchandise, concessions, goods, and checking-in.

According to one embodiment, the customer relations server comprises a geolocation module configured to determine a location of a client device and a venue interface configured to generate ticket offers based on the location of the client device and check-in upon entering a given venue location. The venue interface may be integrated with ticketing sales and distribution services from a venue server through an application programming interface. The customer relations server further comprises an e-commerce interface configured to provide the client device with an ability to purchase merchandise from advertiser and merchant devices based on a determination that the client device has checked in.

The venue interface may be further configured to issue digital tickets to the client device for scanning upon admission or check in at the given venue location. The e-commerce interface may be further configured to provide the client device with an ability to specify delivery of the merchandise directly to a seat during intermission, held for pickup after a show, or mailed to an address. The customer relations server may further comprise a message generator configured to generate direct-to-consumer messages with offers during intermission from advertiser and merchant devices. The customer relations server may further comprise a chat and social media interface configured to facilitate communications between the client device and other client devices. The customer relations server may further comprise a calendar module configured to create a shared virtual calendar including availability information of the client device and the other client devices. The calendar module may be further configured to facilitate ticket purchase by receiving a selection of a data and time from the client device and transmitting ticket purchase notifications to the other client device, the ticket purchase notifications facilitating purchase transaction completion on the other client devices.

According to one embodiment, the method comprises determining a location of a client device based on location sensor data received from the client device, determining an offer to an event at a venue is available based on the location of the client device, generating a message notifying the client device of the offer, determining the client device is checked-in to the venue, monitoring for merchandise or concession orders via the client device during the event, fulfilling the merchandise or concession orders by communicating the orders to a commerce or point-of-sale system, and generating offers associated with the venue at the end of the event.

The message comprises a short message service (“SMS”) message, an e-mail message, or an in-application message to the client device. The offers associated with the venue may include offers to see a same show again or premium content about a show, actors, creative team, and/or producers. The offers associated with the venue may include recommendations of other shows of a same theater company or producing partners. The offers associated with the venue may include recommendations based on a user's demographics and a category of the event to continue relationship for regional, touring productions.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a computing system according to an embodiment of the present invention.

FIG. 2 illustrates customer relations server according to an embodiment of the present invention.

FIG. 3 illustrates a flowchart of a method for facilitating transactions at a venue according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present application discloses a system including a business-to-consumer application and interface that provides event producers and venues with a solution to break the barriers to engagement and sales with patrons, potential patrons and fans. By utilizing Global Positioning System (“GPS”), wireless network communications, and direct messaging, the disclosed system may help digitally streamline existing patrons' access to ticketing, concessions, merchandise and special opportunities. The system may offer contactless interaction, facilitate continuity of relationship after the patron concludes an in-person interaction, and engage potential patrons via geo-location at an event they might otherwise have not engaged with, thereby creating new revenue streams and enhancing existing ones. The system may also engage with consumers before, during, and after events at venues via direct messaging. As such event producers, venues, and other parties can offer their consumers a quick and safe way to connect without direct engagement.

The disclosed system may provide a revenue generator and complementary services for production companies, producers and theaters concerned with successfully navigating significant issues facing theaters due to viral pandemic fears. By increasing sales, deepening relationships and enhancing profit margins all while minimalizing personal interaction, mitigating risk and with minimal cost to the producers, the disclosed system may provide welcome financial relief to producers and comfort to consumers, especially during times of viral outbreaks. The disclosed system may enable producers to interact with an exponentially larger audience for an unlimited amount of time where they can be upsold and delivered tickets, concessions, merchandise, content etc., in a safe and easy manner that limits personal interaction. Local and non-local retailers may also be able to directly message users of the disclosed system to offer discounts etc., based on their current location. For example, a person walking by a restaurant establishment may receive an alert via the disclosed system to offer the person to come in at that moment, or within a period of time, for 10% off a burger.

The disclosed system may be deployed in multiple business sectors including theaters, concerts, movies, movie theaters, live conventions, sporting events, and general retail. For example, the disclosed system may be used in films and movie theaters to provide the “upsells” before, during and after the films. Concert halls and touring companies may use the disclosed system to expand concert ticketing, merchandise, concessions, and take the in-person concert experience to the next level. In comic conventions and similar events where thousands of people visit booths, see panels, and shop for special memorabilia, the disclosed system may streamline the labyrinth-like experience for guests by providing purchasing opportunities online (in and around specific panels), create special experiences and content for patrons and fans, and have a digitized and easy way to get purchases mailed to their homes. For sporting events, much like concerts and theaters, live events like sports make for long lines for concessions and enormous difficulty to buy and keep memorabilia safe. The disclosed system may streamline distribution to keep the focus on the field.

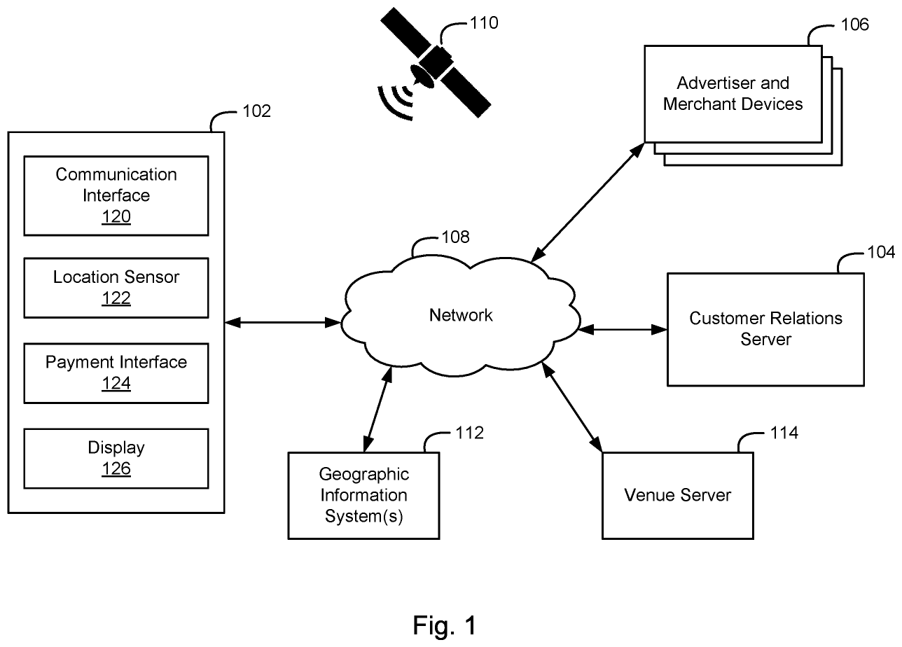

FIG. 1 illustrates a computing system according to an embodiment of the present invention. The system presented in FIG. 1 includes client device 102, customer relations server 104, advertiser and merchant devices 106, network 108, satellites 110, geographic information systems 112, and venue server 114. Client device 102 may comprise a computing device (e.g., laptops, personal digital assistants (PDA), cellular phones, smartphones, tablet computers, e-book readers, smart watches and smart wearable devices, or any computing device having a central processing unit and memory unit capable of connecting to a network). The client device 102 may include communication interface 120, location sensor 122, payment interface 124, and display 126.

Client device 102 may vary in terms of capabilities or features. For example, a web-enabled client device 102, which may include one or more physical or virtual keyboards, mass storage, one or more accelerometers, one or more gyroscopes, global positioning system (GPS) or other location identifying type capability in conjunction with location sensor 122, or a display 126 with a high degree of functionality, such as a touch-sensitive color 2D or 3D display. Client device 102 may comprise a graphical user interface (GUI) or a browser application provided on display 126 (e.g., monitor screen, LCD or LED display, projector, etc.). A client device 102 may also include or execute an application to communicate content, such as, for example, textual content, multimedia content, or the like. Client device 102 may also include or execute an application to perform a variety of possible tasks, such as browsing, searching, playing various forms of content, including locally stored or streamed video, or games.

Client device 102 may include or execute a variety of operating systems, including a personal computer operating system, such as a Windows, Mac OS or Linux, or a mobile operating system, such as iOS, Android, or Windows Phone, or the like. A client device 102 may include or may execute a variety of possible applications, such as a client software application enabling communication via communication interface 120 with other devices, such as communicating one or more messages, such as via email, short message service (SMS), or multimedia message service (MMS), including via a network, as well as a social network, including, for example, Facebook, LinkedIn, Twitter, Pinterest, Snapchat, or Instagram, to provide only a few possible examples. The term “social network” refers generally to a network of individuals, such as acquaintances, friends, family, colleagues, or co-workers, coupled via a communications network or via a variety of sub-networks.

Under instructions from a software application installed on the client device 102, client device 102 may obtain its current location (e.g., geographic coordinates) using satellites 110 (GPS/GLONASS/GNSS, Galileo, BeiDou, IRNSS, QZSS, Doris, Loran, or other geo-positioning systems) using location sensor 122. Alternatively, the current location of the mobile client device may be determined using triangulation of radio/cellular signals, WiFi positioning, IP address geolocation, and/or other mobile device tracking techniques. Data representative of the client device 102 location (i.e., location data) may be transmitted from the client device 102 to customer relations server 104 via network 108.

Network 108 may be any suitable type of network allowing transport of data communications across thereof. The network 108 may couple devices so that communications may be exchanged, such as between servers and client devices or other types of devices, including between wireless devices coupled via a wireless network, for example. Network 108 may also include mass storage, such as network attached storage (NAS), a storage area network (SAN), cloud computing and storage, or other forms of computer or machine readable media, for example. In one embodiment, the network 108 may be the Internet, following known Internet protocols for data communication, or any other communication network, e.g., any local area network (LAN) or wide area network (WAN) connection, cellular network, wire-line type connections, wireless type connections, or any combination thereof. Communications and content transmitted between devices over network 108 may be encrypted using, for example, the Advanced Encryption Standard (AES) with a 128, 192, or 256-bit key size, or any other encryption standard known in the art.

Advertiser and merchant devices 106 may add entries to a location-based offering database at customer relations server 104 to notify users of offers based on location data of the users and the users' proximity to the geographic location. Customer relations server 104 may determine that a user of client device 102 enters or is proximate to a geographic location and subsequently notify the user of an offer from the location-based offering database, such as by sending messages, e.g., SMS, e-mail messages, or in-application messages or notifications to the client device 102. The messages may include information about the offer, such as the name and address of a merchant/event/venue, conditions of the offer, time limits, etc. Additionally, the user may use client device 102 to query customer relations server 104 for information about offers that have associated geographic locations that are proximate to the current or last known locations of the user or locations specified by the user, such as locations the user expects to be in the future. For example, a user may create interactive queries, review location information, edit location data and maps, and customer relations server 104 may present the results of these operations in a graphical user interface on display 126.

Location data from client device 102 may retrieved by or transmitted to customer relations server 104 for interpretation by customer relations server 104 referencing geographic information system(s) 112. Geographic information system(s) 112 may comprise computer systems for capturing, storing, checking, and displaying data related to positions in a physical environment. Using the geographic information system(s) 112, the location data may be correlated by customer relations server 104 with offers in the location-based offering database. Client device 102 may further interact with customer relations server 104 to conduct transactions with advertiser and merchant devices 106 and venue server 114, such as purchasing tickets, merchandise, concessions and other goods, and checking-in. Customer relations server 104 may further facilitate processing of payments with payment interface 124 for any conducted transaction.

Customer relations server 104, as described herein, may vary widely in configuration or capabilities but is comprised of at least a special-purpose digital computing device including at least one or more central processing units and memory. The customer relations server 104 may also include one or more of mass storage devices, power supplies, wired or wireless network interfaces, input/output interfaces, and operating systems, such as Windows Server, Mac OS X, Unix, Linux, FreeBSD, or the like. In an exemplary embodiment, customer relations server 104 may include or have access to memory for storing instructions or applications for the performance of various functions and a corresponding processor for executing stored instructions or applications. For example, the memory may store an instance of the customer relations server 104 configured to operate in accordance with the disclosed embodiments.

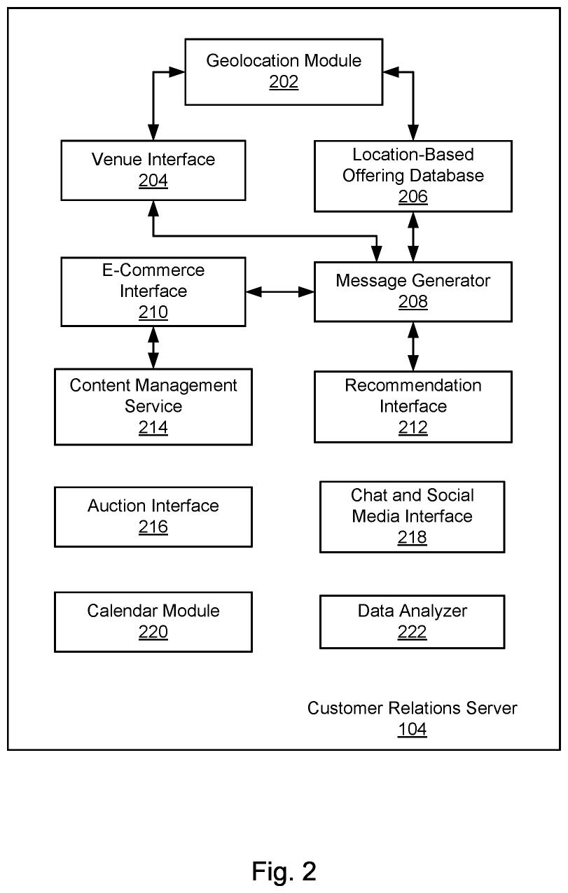

FIG. 2 presents a customer relations server according to an embodiment of the present invention. Customer relations server 104 may provide functionality that allows businesses and venues to engage with a user of client device 102 before, during, and after events at the venues via messages or notifications. The customer relations server 104 may include a venue interface 204 coupled to a geolocation module 202 and message generator 208 for providing real-time ticket sales to client device 102 based on a user's location. For example, venue interface 204 may generate live, direct-to-consumer ticket offers to an event at a venue using location data received from the client device 102 (e.g., walks by theater or ticket booth) or preference, enabling producers and venues to make real-time decisions about available tickets with quick purchasing avails. Location data from the client device 102 may retrieved by or transmitted to geolocation module 202. Geolocation module 202 may include an interface or functionality that uses geographic information provided by third-party mapping software or technology to determine a location of the client device 102.

The venue interface 204 may be integrated with ticketing sales and distribution services (e.g., provided by a venue server) through an application programming interface (API) or directly to a box office. Venue interface 204 may further generate offers for purchasing seat upgrades based on live and current availability. Customer relations server 104 may also allow client device 102 to scan and/or check-in tickets of customers upon entering a given location or vicinity of the venue through the venue interface 204. Contactless ticketless entry for admission may be implemented via venue interface 204 issuing digital tickets where the digital tickets may be displayed to the client device 102 for scanning upon admission, or check in upon arrival and then shown to attendant. A “fastpass” or VIP (very important person) contactless entry via escort to seats at a specifically reserved time may also be provided through the venue interface 204.

The customer relations server 104 may further include location-based offering database 206 that is communicatively coupled to message generator 208. Location-based offering database 206 may store entries (from advertiser and merchant devices 106) that are used to notify users of offers from various businesses based on the users' proximity to given geographic locations. The entries may include a merchant name, street address (e.g., city, state, zip code, geographic coordinates, intersection, neighborhood or landmark), telephone number, the nature of the offer, what is being offered, conditions of the offer, time limits, etc. Message generator 208 may generate and send a message to client device 102 that includes live, direct-to-consumer discounts for retail, food and other businesses. For example, a user of client device 102 may walk by an establishment and receive a message with a 10% off discount or a 25% off discount with a ticket purchase.

E-commerce interface 210 may determine that a client device 102 has checked in to a venue via venue interface 204 and provide client device 102 with an ability to purchase merchandise at the venue by communicating with, e.g., merchandise staff and delivery staff (if different) from advertiser and merchant devices 106, as part of a customer and venue experience. Contactless purchases of show or brand merchandise may be conducted digitally anywhere, anytime (whether standing in-line prior to the show or from their seat) with e-commerce interface 210 from the client device 102. The merchandise may be specified to be delivered directly to a seat during intermission, held for pickup after the show, or mailed to an address specified by the purchaser. The e-commerce interface 210 may be further used by client device 102 to submit requests to pre-order concessions to be delivered to seats during intermission or be picked up at a concessions counter by communicating with, e.g., concessions staff and delivery staff (if different) from advertiser and merchant devices 106. Referral links and/or code may also be provided by customer relations server 104 to client device 102 after purchases are made through the e-commerce interface 210 or within a period of time of leaving a location to receive special discounts or credit when referred customers perform a given transaction.

Advertiser and merchant devices 106 may communicate with message generator 208 via E-commerce interface 210 to generate direct-to-consumer messages with special offers during intermission (for example, an alert asking if the user would like to purchase and download a soundtrack, purchase a t-shirt or digital program, etc.). A timer of a predetermined duration may be configurable to inform message generator 208 when to activate/deactivate the intermission feature. Special offers may also be generated by message generator 208 for the user to see the same show again by, for example, providing coupon codes based on instructions from advertiser and merchant devices 106. Content management service 214 may also be coupled to e-commerce interface 210 to provide the client device 102 with access to premium content about, for example, a show, actors, creative team and producers after seeing the show (for additional cost or as part of ticket sale) as well as pop-culture stylized content to continue engagement with younger demographic (quizzes, etc.) from venue server 114.

Recommendation interface 212 may generate short-term and long-term recommendations using, e.g., artificial intelligence learning of users to personalize recommendations combined with localization. Short-term recommendation may include high-level recommendations, e.g., about other shows of the same theater company or producing partners etc., along with availability for ticket purchase. Long-term recommendations may include direct-to-mobile theatre/arts/experience recommendations based on a user's home zip code and criteria from a show/experience that the user just saw to continue relationship for regional, touring productions, etc. Customer relations server 104 may further include an auction interface 216 to enable client device 102 to bid on items or experiences offered by a venue (e.g., venue interface 204) or advertiser and merchant devices 106, such as special experiences after the show, such as meet and greet with cast, signed posters, behind the scenes tours, etc.

A chat and social media interface 218 may allow client device 102 to chat with fans (e.g., on other client devices) in real-time through social networks or a chat feature. The chat and social media interface 218 may access information from a user's social networking account and use the information to facilitate the chat. A user of client device 102 may also chat with friends through the chat and social media interface 218 to coordinate buying tickets together using shared availability calendars via calendar module 220 for other future shows. Calendar module 220 may provide shared calendar functionality with “add friend” and “remove friend” features. A user's availability may be added in a shared virtual calendar in a personal color and times of friends (displayed in other colors) are free may be automatically highlighted on the virtual calendar. The user may select a date/time and send ticket purchase notifications to each friend through the calendar module 220 to complete a purchase transaction on their respective devices. The purchase transaction may be split among the group of individuals in the virtual calendar to divide the cost of tickets.

Data analyzer 222 may generate and store analytic data in a central database that may be accessed by venue server 114, e.g., producers, production companies and theaters about patrons spending habits, etc., via an API. Access to the analytic data may be configurable based on a subscription service level.

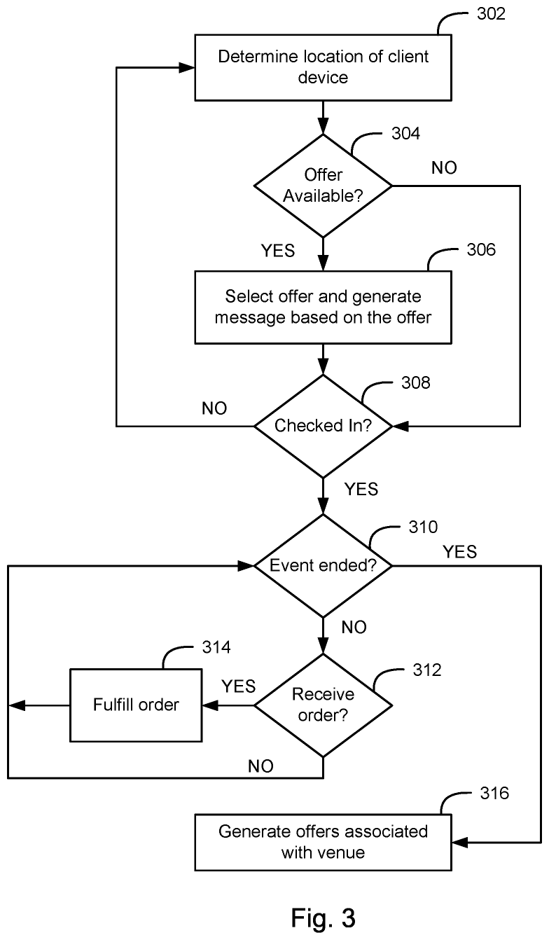

FIG. 3 presents a flowchart of a method for facilitating transactions at a venue according to an embodiment of the present invention. Businesses and venues may engage with consumers before, during, and after events at the venues via messages or notifications sent by the disclosed system. A location of a client device is determined, step 302. Location data may be received from the client device and used to determine a user's location. The system determines whether an offer is available from a database of offers from businesses or retailers within a vicinity of the user's location, step 304. For example, the offers may include tickets to events at a venue within a vicinity of the user's location. According to another embodiment, determining whether an offer is available may include the system determining an event the user of the client device is attending.

If an offer is available, the offer is selected and a message is generated based on the offer, step 306. The message may include details of the offer and include a link or instructions to facilitate a purchase associated with the offer. Selecting the offer may include selecting an offer related to the event or within the vicinity of a venue hosting the event. An offer may also be selected in accordance to relevancy, bid rank, or context. The message may notify the user of the client device of the offer that is based on the user's location or the user's proximity to a geographic location. The system may send messages, e.g., SMS, e-mail messages, or in-application messages or notifications to the client device of such an offer. The messages may include information about the offer, such as the name and address of the merchant, conditions of the offer, time limits, etc. As such, the system may generate live, direct-to-consumer offers, for example, when a user of the client device walks by a business.

The system may then proceed to determine whether the user of the client device is checked-in to a venue corresponding to the offer upon generating the message based on the offer, step 308. Determining whether the user of the client device is checked-in to the venue may include communicating with a venue server to verify that the user or the client device has scanned a ticket at the venue. If the user is not checked-in, the system may return to determining the location of the client device in step 302. Otherwise, if the user is checked-in to a venue, the system may determine whether the event has ended, step 310. The system may continuously monitor for merchandise or concession orders from the client device during an event (i.e., event has not ended), step 312. If the system receives a merchandise or concession order, the system fulfills the order, step 314. Fulfilling the order may include communicating an order request to a commerce or point-of-sale system for order execution.

If the event is determined to have ended in step 310, offers associated with the venue are generated, step 316. For example, special offers may be generated for the user to see the same show again by, for example, providing coupon codes. The user may also be offered access to premium content about, for example, a show, actors, creative team and producers after seeing the show. Artificial intelligence learning of the user may be used to generate the offers associated with the venue. The offers associated with the venue may also include short-term and long-term recommendations. For example, short-term recommendations may include other shows of the same theater company or producing partners etc., along with availability for ticket purchase. Long-term recommendations may include recommendations based on a user's demographics and a category of the event to continue relationship for regional, touring productions, etc.

FIGS. 1 through 3 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A system for facilitating transactions at a venue, the system comprising:
a processor; and
a memory having executable instructions stored thereon that when executed by the processor cause the processor to:
determine a location of a client device based on location sensor data received from the client device;
select an offer based on the location of the client device and an event at a venue a user of the client device is attending; and
generate a message to the client device based on the offer.

2. The system of claim 1 further comprising the processor configured to:
add entries to a location-based offering database including offers based on geographic locations;
determine that the client device entered or is proximate to a given one of the geographic locations; and
generate an offer corresponding to the given one of the geographic locations.

3. The system of claim 1 wherein the message includes at least one of a name and address of a merchant, conditions of the offer, and a time limit of the offer.

4. The system of claim 1 further comprising the processor configured to receive a query from the client device for information about offers that have associated geographic locations that are proximate to the location of the client device.

5. The system of claim 1 further comprising the processor configured to receive a query from the client device for information about offers that have associated geographic locations that are proximate to a future location intended.

6. The system of claim 1 further comprising the processor configured to interact with a customer relations server to conduct transactions with advertiser and merchant devices or a venue server.

7. The system of claim 6 wherein the transactions include purchasing of tickets, merchandise, concessions, goods, and checking-in.

8. A customer relations server for facilitating transactions at a venue, the customer relations server comprising:
a geolocation module configured to determine a location of a client device;
a venue interface configured to generate ticket offers based on the location of the client device and check-in upon entering a given venue location, the venue interface integrated with ticketing sales and distribution services from a venue server through an application programming interface; and
an e-commerce interface configured to provide the client device with an ability to purchase merchandise from advertiser and merchant devices based on a determination that the client device has checked in.

9. The customer relations server of claim 8 wherein the venue interface is further configured to issue digital tickets to the client device for scanning upon admission or check in at the given venue location.

10. The customer relations server of claim 8 wherein the e-commerce interface is further configured to provide the client device with an ability to specify delivery of the merchandise directly to a seat during intermission, held for pickup after the event, or mailed to an address.

11. The customer relations server of claim 8 further comprising a message generator configured to generate direct-to-consumer messages with offers during intermission from advertiser and merchant devices.

12. The customer relations server of claim 8 further comprising a chat and social media interface configured to facilitate communications between the client device and other client devices.

13. The customer relations server of claim 8 further comprising a calendar module configured to create a shared virtual calendar including availability information of the client device and the other client devices.

14. The customer relations server of claim 13 wherein the calendar module is further configured to facilitate ticket purchase by receiving a selection of a data and time from the client device and transmitting ticket purchase notifications to the other client device, the ticket purchase notifications facilitating purchase transaction completion on the other client devices.

15. A method, in a data processing system comprising a processor and a memory, for facilitating transactions at a venue, the method comprising:
determining a location of a client device based on location sensor data received from the client device;
determining an offer to an event at a venue is available based on the location of the client device;
generating a message notifying the client device of the offer;
determining the client device is checked-in to the venue;
monitoring for merchandise or concession orders via the client device during the event;
fulfilling the merchandise or concession orders by communicating the orders to a commerce or point-of-sale system; and
generating offers associated with the venue at the end of the event.

16. The method of claim 15 wherein the message comprises a short message service (“SMS”) message, an e-mail message, or an in-application message to the client device.

17. The method of claim 15 wherein the offers associated with the venue include offers to see a same show again or premium content about a show, actors, creative team, and/or producers.

18. The method of claim 15 wherein the offers associated with the venue include recommendations of other shows of a same theater company or producing partners.

19. The method of claim 15 wherein the offers associated with the venue include recommendations based on a user's demographics and a category of the event to continue relationship for regional, touring productions.
